(19) United States
(12) Patent Application Publication
(10) Pub. No.: US 2026/0326299 A1
(43) Pub. Date: Oct. 22, 2026

(54) ROBOT, CONTROL METHOD, MANUFACTURING METHOD, SYSTEM, AND RECORDING MEDIUM

(71) Applicant: CANON KABUSHIKI KAISHA, Tokyo (JP)

(72) Inventor: ISAMU OKUMA, Tokyo (JP)

(21) Appl. No.: 19/629,885

(22) Filed: Mar. 26, 2026

(30) Foreign Application Priority Data
Apr. 21, 2025 (JP) 2025-069575

(51) Int. Cl. B25J 9/16

(52) U.S. Cl. CPC B25J 9/1674; B25J 9/1687

(57) ABSTRACT

A robot includes a movable unit, and a control unit configured to control an operation of the movable unit. The robot is configured to perform, together with an operator, work on a member placed on a movable device. The control unit is configured to control an operation of the movable unit based on information regarding a position of the movable device.

### BACKGROUND

### Field of the Technology

The present disclosure relates to a robot, a robot control method, and the like.

### Description of the Related Art

In recent years, robots for performing work in collaboration with humans have been developed. For example, it has been attempted that an operator and a robot perform assembly work for a product in collaboration with each other. In such a production site, it is required to improve productivity by causing the robot to perform assembly work at high speed while ensuring safety of the operator.

JP 2008-191823 A describes a technology for ensuring productivity while ensuring safety in a hazardous region where a work space of a robot and a work space of a human overlap. Specifically, the entry of the robot into the hazardous region or the entry of the human operator is monitored using first and second light curtains. When only one of the robot and the operator enters a work area, a safety input from one light curtain that has sensed the entry is invalidated, and operation of the robot is continued to maintain the productivity based on a valid safety input from another light curtain. On the other hand, when the other one of the robot and the operator also enters the work area, driving of the robot is stopped based on the valid safety input from the other light curtain to ensure safety.

In the robot described in JP 2008-191823 A, when both the operator and the robot simultaneously enter the work area to perform work, the robot is stopped, for example, in order to ensure safety. Therefore, the operator and the robot cannot work at the same time, and it is thus difficult to speed up assembly work. Alternatively, restricting a work procedure of the operator to prevent the stop of the robot may lead to a decrease in efficiency or speed of work performed by the operator.

### SUMMARY

One of the problems to be solved by the embodiments disclosed in the present specification and the drawings is that a technology for improving productivity of collaborative work between a human and a robot while ensuring safety of the human was not provided. However, the problems to be solved by the embodiments disclosed in the present specification and the drawings are not limited to the above problem. A problem corresponding to each effect achieved by each configuration described in the embodiments described below can also be regarded as another problem.

According to a first aspect of the present disclosure, a robot includes a movable unit, and a control unit configured to control an operation of the movable unit. The robot is configured to perform, together with an operator, work on a member placed on a movable device. The control unit is configured to control an operation of the movable unit based on information regarding a position of the movable device.

According to a second aspect of the present disclosure, a control method for controlling a robot that includes a movable unit and a control unit configured to control an operation of the movable unit and is configured to perform, together with an operator, work on a member placed on a movable device is provides. The control method includes controlling, by the control unit, the operation of the movable unit based on information regarding a position of the movable device.

According to a third aspect of the present disclosure, a system includes a robot including a movable unit, a control unit configured to control an operation of the movable unit, and a movable device. The robot is configured to perform, together with an operator, work on a member placed on the movable device. The control unit is configured to control the operation of the movable unit based on information regarding a position of the movable device.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic external view of a robot that performs component assembly work together with an operator when viewed from above.

FIG. 2 is a schematic external view of an example of a situation where no work cart is disposed at a first position when viewed from above.

FIG. 3 is a schematic view of a robot that performs work together with the operator and a safety fence when viewed from obliquely above.

FIG. 4 is a schematic view of the robot that performs work together with the operator when viewed from obliquely above.

FIG. 5 is a schematic view of an example of a situation in which no work cart is disposed at the first position when viewed from obliquely above.

FIG. 6 is a schematic block diagram illustrating a configuration of a control system of the robot.

FIG. 7 is a schematic diagram illustrating a configuration of a main body and the like of the robot.

### DESCRIPTION OF THE EMBODIMENTS

A robot, a robot control method, and the like according to an embodiment of the present disclosure will be described with reference to the drawings. The embodiment described below is merely an example, and for example, detailed configurations can be appropriately changed and implemented by those skilled in the art without departing from the gist of the present disclosure.

In the drawings referred to in the following embodiment and description, elements denoted by the same reference numerals have similar functions unless otherwise specified. In the drawings, in a case where a plurality of the same elements are arranged, reference numerals and descriptions thereof may be omitted.

In addition, the drawings may be schematic for convenience of illustration and description, and thus, the shape, size, arrangement, and the like of elements in the drawings may not strictly match those of actual ones. In addition, “XX or more and YY or less” or “XX to YY” representing a numerical range means a numerical range including end points XX (lower limit) and YY (upper limit) unless otherwise specified. When numerical ranges are described in stages, the upper limit and the lower limit of each numerical range can be arbitrarily combined.

### Embodiment

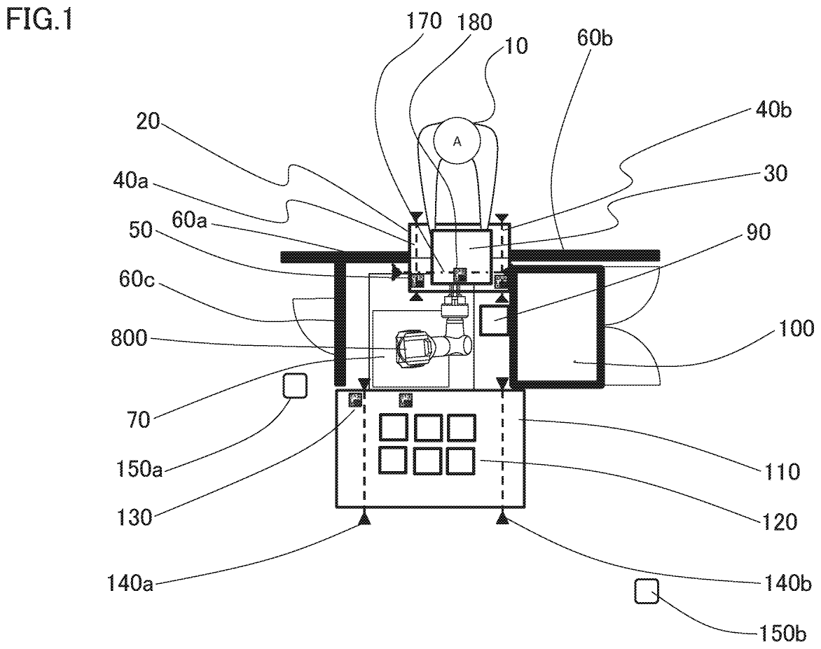

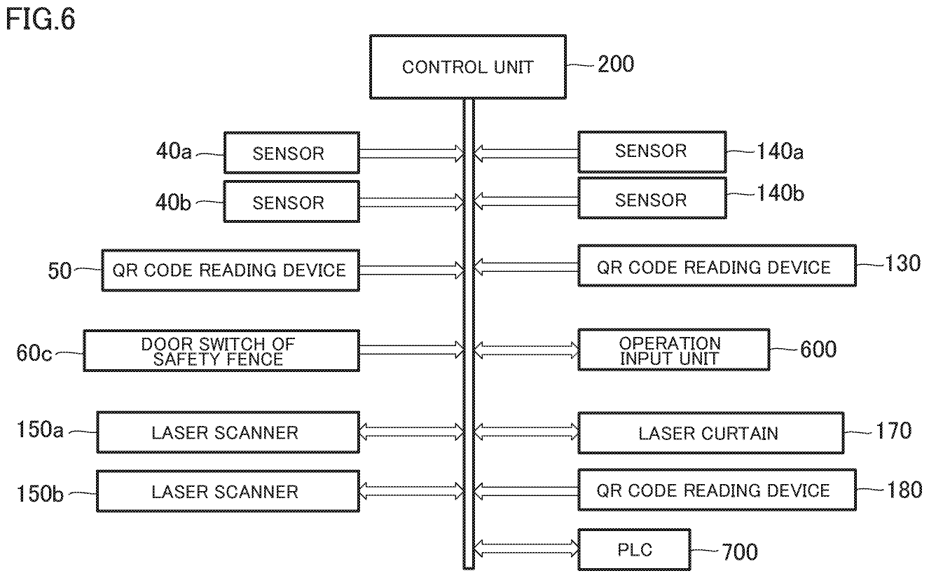

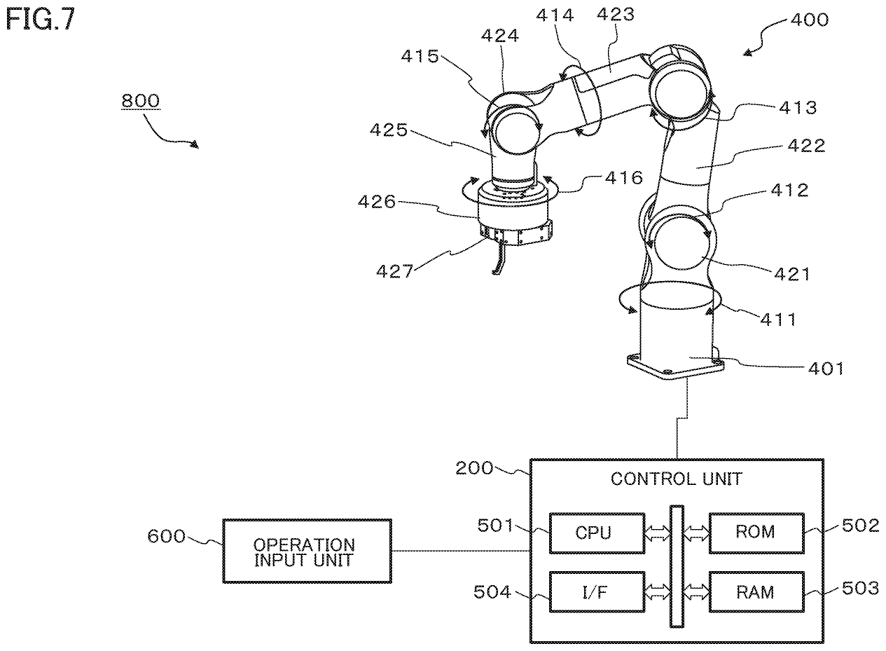

As an embodiment, a robot that performs work in collaboration with a human operator will be described with an example. FIG. 1 is a schematic external view of the robot that performs component assembly work together with the operator when viewed from above. Positional Relationship between Work Cart And Robot During Collaborative Work A robot 800 is fixed on a robot frame 70 installed on a floor. The robot 800 is a robot that performs component assembly work together with an operator 10 on a component 30 to be assembled (member) placed on a work cart 20 (movable device). A configuration of the robot 800 is described below with reference to FIGS. 6 and 7. The work cart 20 is a device having an upper surface on which the component 30 to be assembled can be placed, the device being movable by power or human power of the operator.

FIG. 1 illustrates a state in which the work cart 20 is disposed at a first position. The first position is a position where the work cart 20 is disposed when the robot 800 and the operator 10 collaboratively perform the component assembly work on the component 30 to be assembled placed on the work cart 20. A position of the operator 10 when the operator 10 performs work on the component 30 to be assembled using his/her hand is set in advance as a second position. The second position is desirably illustrated on the floor as, for example, a standing position of the operator so that the operator can safely and efficiently perform the component assembly work.

The first position and the second position are set as follows with respect to a position where the robot 800 is fixed. That is, the first position is set to a position where the robot 800 can perform work on the component 30 to be assembled and the operator 10 can perform work on the component 30 to be assembled from the second position. In other words, the first position where the work cart 20 is disposed is set between the second position set as the position of the operator when performing work on the component 30 to be assembled and the position where the robot 800 is installed.

The operator 10 performs the component assembly work on the component 30 to be assembled on an upper side in FIG. 1, and the robot 800 performs the component assembly work on the component 30 to be assembled on a lower side in FIG. 1. That is, when the work cart 20 on which the component 30 to be assembled is placed is disposed at the first position, the robot 800 performs work on the component 30 to be assembled on a side opposite to the second position where the operator 10 is positioned. By setting such a positional relationship, the operator 10 and the robot 800 can perform the component assembly work on the component 30 to be assembled on opposite sides without physically interfering with each other. Therefore, an operation speed of the robot 800 can be increased while ensuring safety of the operator.

In the present embodiment, a control unit that controls an operation of the robot 800 controls the operation of the robot 800 based on information regarding a position of the work cart 20 (device). That is, the control of the operation of the robot 800 is changed according to whether or not the work cart 20 is disposed at the first position. In a case where the work cart 20 is disposed at the first position, the operation is controlled such that the operation speed of the robot 800 is increased as compared with a case where the work cart 20 is not disposed at the first position. Even in a case where the operator 10 present at the second position is performing work, the operator 10 is separated from the robot 800 by the work cart 20 disposed at the first position, so that safety is ensured. Therefore, the operation speed of the robot 800 can be increased to shorten a work time of the assembly work.

The robot 800 according to the embodiment includes a sensing unit for sensing whether or not the work cart 20 is disposed at the first position so that the control unit can acquire information indicating whether or not the work cart 20 is disposed at the first position. The control unit changes the control of the operation speed of the robot 800 based on the information (sensing result) acquired from the sensing unit.

In the example of FIG. 1, a sensor 40a and a sensor 40b that sense whether or not an object is present at the first position, and an identification unit that identifies whether or not the object present at the first position is the work cart 20 are provided as the sensing units.

The sensor 40a and the sensor 40b may be sensors capable of detecting whether or not an object is present at the first position, such as a sensor including a light emitting unit and a light receiving unit, or a sensor including an ultrasonic transmission source and an ultrasonic reception unit. By installing a predetermined number (two in the illustrated example) of sensors according to a width of the work cart 20, it is possible to sense whether or not the work cart 20 is disposed at the first position.

In a case where the sensor 40a and the sensor 40b are sensors that simply sense the presence of an object, for example, even if the work cart 20 is not disposed at the first position, the human may be erroneously identified as the work cart 20 when the human spreads both arms at the first position. Therefore, in the example of FIG. 1, a marker 50 (two-dimensional barcode) which is a QR code (registered trademark) is attached as an identification marker to the work cart 20, and a marker reading device is provided in the robot 800. Using the detection results of the sensor 40a, the sensor 40b, and the marker reading device, the detection unit can transmit a sensing result as to whether or not the work cart 20 is disposed at the first position to the control unit. The identification marker is not limited to the QR code (registered trademark), and may be a one-dimensional barcode, a character, a figure, or the like. Furthermore, a device implementing the sensing unit and an arrangement thereof are not limited to the example of FIG. 1, and for example, it is also possible to implement the sensing unit by combining a camera and an image recognition unit (computer). In short, it is sufficient if it can be sensed whether or not the work cart 20 is disposed at the first position.

In addition, it is desirable that a marker 180 (two-dimensional barcode), which is a QR code (registered trademark), is attached as an identification marker to the component 30 to be assembled, and a marker reading device is provided in the robot 800. In a case where it can be confirmed that the correct component 30 to be assembled is placed on the work cart 20, it is desirable to control an operation speed for the assembly work performed by the robot 800 to be higher than an operation speed for different work described below.

### Positional Relationship Between Robot and Surrounding Equipment in Performing Collaborative Work

When the robot 800 performs the assembly work on the component 30 to be assembled placed on the work cart 20, if another person, who is different from the operator 10 who performs the work at the second position, enters an operation range of the robot 800, there is a possibility that another person interferes with the robot 800 performing the assembly work at a high speed.

Therefore, in the present embodiment, in order to prevent a person different from the operator 10 from entering a work range of the robot 800, equipment having a height larger than a predetermined height is disposed in a direction different from a direction in which the first position is present in a case of being viewed from the robot 800 in at least a part of the periphery of the robot 800. That is, equipment having a height larger than the predetermined height is disposed at a position different from the first position in at least a part of the periphery of the work range of the robot 800. The predetermined height is a height at which the equipment functions as an obstacle that cannot be unconsciously (or easily) crossed when a human tries to enter the work range of the robot 800, and can be set to, for example, 1000 mm. The predetermined height can be set to 1500 mm.

In the example illustrated in FIG. 1, a safety fence 60a, a safety fence 60b, a safety fence 60c, a component storage 100, and a cart 110 are disposed as pieces of equipment having a height larger than the predetermined height in a direction different from the direction in which the first position is present in a case of being viewed from the robot 800.

That is, with respect to the robot 800, the safety fence 60c is disposed in a direction of approximately 9 o'clock to 11 o'clock, and the safety fence 60a and the safety fence 60b are disposed so as to sandwich the first position. Such safety fences are pieces of equipment that can function as obstacles that cannot be unconsciously (or easily) crossed even if a human tries to enter a work region (movable range) of the robot 800. Like the illustrated safety fence 60c, for example, an openable and closable door may be installed in the safety fence so that a maintenance operator can access the robot at the time of maintenance of the robot 800. In order to enable emergency stop when the door is opened during the operation of the robot 800, it is desirable to provide a mechanism (door switch) that senses an opened/closed state of the door and transmit a sensing result to the control unit of the robot.

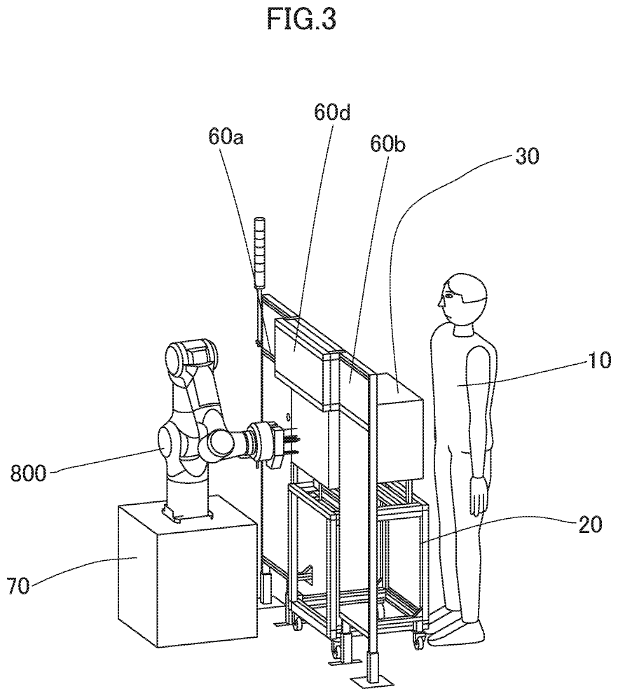

FIG. 3 is a schematic view of a state of the safety fence 60a and the safety fence 60b when the operator 10 is present at the second position where the operator 10 can perform work together with the robot 800 when viewed from diagonally above. For convenience of illustration, the cart 110, the component storage 100, and the safety fence 60c are not illustrated.

As illustrated in FIG. 3, the safety fence 60a and the safety fence 60b are coupled by a safety fence 60d positioned above the work cart 20. In addition, the safety fence 60a, the safety fence 60b, the safety fence 60d, the work cart 20, and the component 30 to be assembled are present between the robot 800 and the operator 10 who performs work at the second position, so that the robot 800 and the operator 10 cannot directly contact each other.

Returning to FIG. 1, the component storage 100 is disposed in a direction of three o'clock with respect to the robot 800. The component storage 100 is equipment that stores a component to be assembled to the component 30 (member) to be assembled, has a height of 1000 mm or more, and can function as an obstacle that cannot be unconsciously (or easily) crossed even if a human tries to enter the work region (movable range) of the robot 800. The component storage 100 may be provided with an opening and closing door for component supply on a side opposite to the robot 800. An operator (not illustrated) can open the opening and closing door to replenish the component to the component storage 100, and the component storage 100 has a partitioned structure that does not allow direct contact between an end effector of the robot 800 and the operator.

In addition, as illustrated in FIG. 1, when the robot 800 performs the assembly work together with the operator 10, the cart 110, which is movable equipment, can be disposed in a direction of six o'clock with respect to the robot 800. The cart 110 may be, for example, an automatic guided vehicle (AGV) or a transport vehicle moved by a human.

The cart 110 can be, for example, a kitting cart that supplies an assembling component 120 to be assembled to the component 30 to be assembled. In this case, the robot 800 picks up the assembling component 120 from the kitting cart, and performs work of assembling the assembling component 120 to the component 30 to be assembled on the work cart 20. A finished product on which the component assembly work by the operator 10 and the robot 800 is completed on the work cart 20 moves together with the work cart 20 in a state of being placed on the work cart 20, and is transported from the first position to a work position of the next process. After all the loaded assembling components 120 are picked up, the cart 110, which is the kitting cart, moves to a component supply site to load a new assembling component 120. The kitting cart disposed in the direction of six o'clock is equipment that has a height larger than the predetermined height and can function as an obstacle that cannot be unconsciously (or easily) crossed even if a human tries to enter the work region (movable range) of the robot 800 from the same direction.

The cart 110 may be, for example, a finished product transport cart that transports the component 30 to be assembled for which the component assembly work is completed. In this case, the robot 800 transfers the finished product on which the component assembly work is completed on the work cart 20 onto the finished product transport cart. When a predetermined number of finished products are loaded on the finished product transport cart, the finished product transport cart transports the finished product to the work position of the next process. The finished product transport cart disposed in the direction of six o'clock is equipment that has a height larger than the predetermined height and can function as an obstacle that cannot be unconsciously (or easily) crossed even if a human tries to enter the work region (movable range) of the robot 800 from the same direction.

In addition, the cart 110 can be, for example, a cart that supplies the component 30 to be assembled to which no component is assembled. In this case, the robot 800 picks up the component 30 to be assembled from the cart 110 and places the component 30 to be assembled on the work cart 20 so that the operator 10 and the robot 800 can perform the component assembly work in collaboration with each other. The finished product on which the component assembly work by the operator 10 and the robot 800 is completed on the work cart 20 moves together with the work cart 20 in a state of being placed on the work cart 20, and is transported from the first position to a work position of the next process. In addition, after all the loaded components 30 to be assembled are picked up, the cart 110 moves to the component supply site to load a new component 30 to be assembled. The cart 110 disposed in the direction of six o'clock has a height larger than the predetermined height, and is equipment that can function as an obstacle that cannot be unconsciously (or easily) crossed even if a human tries to enter the work region (movable range) of the robot 800 from the same direction.

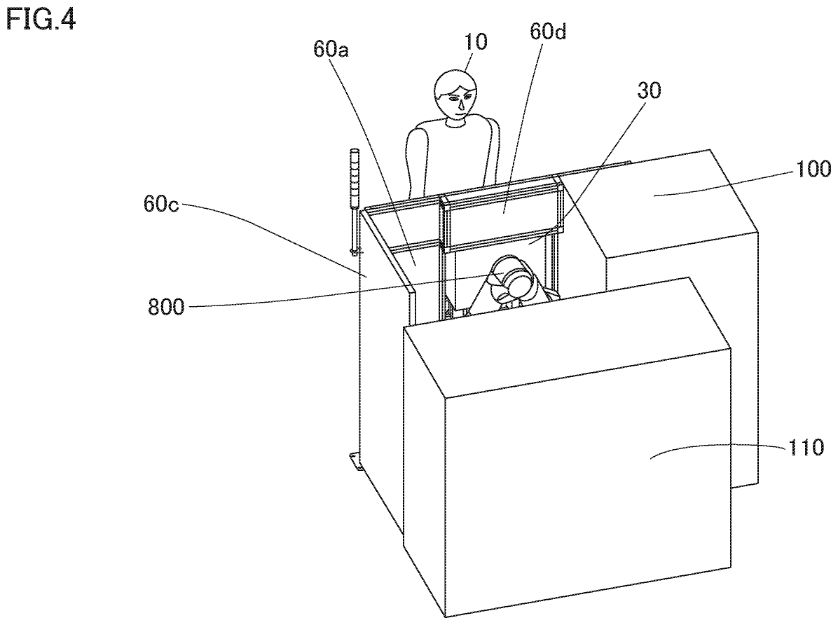

FIG. 4 is a schematic view of the robot 800 that performs work together with the operator 10 who is present at the second position when viewed from obliquely above. The work cart 20, the component 30 to be assembled, and the safety fence 60d are disposed between the robot 800 and the operator 10 who performs work at the second position (work position), and the operator 10 and the robot 800 are prevented from interfering with each other. In addition, the periphery of the work range (movable range) of the robot 800 is surrounded by pieces of equipment such as the work cart 20, the safety fences 60a to 60d, the component storage 100, and the cart 110. The equipment has a height larger than the predetermined height, and functions as an obstacle that cannot be unconsciously (or easily) crossed even if a human tries to enter the work region (movable range) of the robot 800.

The robot 800 according to the embodiment includes a sensing unit for sensing whether or not the cart 110 is disposed at a predetermined position so that the control unit can confirm that the cart 110 is disposed at the predetermined position in a direction of six o'clock when performing the component assembly work that is collaborative work. Then, in a case where it is confirmed that the cart 110 is disposed at the predetermined position based on a sensing result acquired from the sensing unit, the control unit causes the robot 800 to perform the component assembly work at a higher operation speed.

In the example of FIG. 1, a sensor 140a and a sensor 140b that sense whether or not an object is present at a predetermined position in the direction of six o'clock, and an identification unit that identifies whether or not the object present at the predetermined position is the cart 110 are provided as the sensing units.

The sensor 140a and the sensor 140b may be sensors capable of detecting whether or not an object is present at the predetermined position in the direction of 6 o'clock, such as a sensor including a light emitting unit and a light receiving unit, or a sensor including an ultrasonic transmission source and an ultrasonic reception unit. By installing a predetermined number (two in the illustrated example) of sensors according to a width of the cart 110, it is possible to sense whether or not the cart 110 is disposed at the predetermined position.

In a case where the sensor 140a and the sensor 140b are sensors that simply sense the presence of an object, for example, even if the cart 110 is not disposed at the predetermined position, the human may be erroneously identified as the cart 110 when the human spreads both arms at the predetermined position. Therefore, in the example of FIG. 1, a marker 130 (two-dimensional barcode), which is a QR code (registered trademark), is attached as an identification marker to the cart 110, and a marker reading device is provided in the robot 800. Using the detection results of the sensor 140a, the sensor 140b, and the marker reading device, the detection unit can transmit a sensing result as to whether or not the cart 110 is disposed at the predetermined position to the control unit. The identification marker is not limited to the QR code (registered trademark), and may be a one-dimensional barcode, a character, a figure, or the like. Furthermore, a device implementing the sensing unit and an arrangement thereof are not limited to the example of FIG. 1, and for example, it is also possible to implement the sensing unit by combining a camera and an image recognition unit (computer). In short, it is sufficient if it can be sensed whether or not the cart 110 is disposed at the predetermined position.

As described above, in the present embodiment, when the robot 800 and the operator 10 perform the component assembly work in collaboration with each other with the work cart 20 interposed therebetween, the control of the operation is changed so as to increase the operation speed of the robot 800. Even in a case where the operator 10 is performing work at the second position, the operator 10 is separated from the robot 800 by the work cart 20 disposed at the first position, so that safety is ensured. Therefore, the operation speed of the robot 800 can be increased to shorten a work time of the assembly work.

Furthermore, when the robot 800 and the operator 10 perform the component assembly work in collaboration with each other, equipment having a height larger than the predetermined height is disposed in a direction different from a direction in which the first position is present in a case of being viewed from the robot 800 in at least a part of the periphery of the robot 800. Desirably, the pieces of equipment are disposed so as to substantially surround the periphery of the work range (movable range) of the robot 800 except for the first position where the cart 110 is disposed. The expression “substantially surround” refers to a state in which there is no gap around the robot 800 through which a human can pass unconsciously (or easily), and for example, it is sufficient if the pieces of equipment are disposed such that a gap between the pieces of equipment is 300 mm or less. As described above, according to the present embodiment, when the robot 800 and the operator 10 perform the component assembly work in collaboration with each other, it is possible to prevent a person different from the operator 10 who performs work at the second position from entering the operation range of the robot 800. Therefore, the operation speed of the robot 800 can be increased to shorten a work time of the assembly work.

### Case Where Robot Performs Work Different From Collaborative Work

In a case where the work cart 20 is not disposed at the first position, the robot 800 does not collaborate with the operator 10 to perform the component assembly work on the component 30 to be assembled, but can perform different work. Examples of the work include work of picking up a component from the component storage 100 in advance for preparation of the next assembly work, and work of attaching and detaching a hand (manipulator) to and from a robot arm on a hand attachment and detachment workbench 90.

When work different from the component assembly work is performed, in a case where the work cart 20 is not disposed at the first position, there is no obstacle at the first position, and a human may enter the work range of the robot 800 from the first position and interfere with the robot 800.

Therefore, in the present embodiment, in order to enhance the safety when performing work different from the component assembly work, in a case where the robot 800 is operated when the work cart 20 is not disposed at the first position, the robot 800 is operated at an operation speed lower than that for the component assembly work. A method for acquiring, by the control unit of the robot 800, information indicating whether or not the work cart 20 is disposed at the first position is as described above.

In a case where the work cart 20 is not disposed at the first position, the control unit lowers the operation speed of the robot 800 when performing work different from the component assembly work than that for the component assembly work. This is because, as long as the robot 800 operates at a low speed, even if a human accidentally enters the movable range of the robot, the human can easily avoid an interference with the robot 800, and even if the human accidentally comes into contact with the robot 800, such contact does not lead to a serious situation. On the other hand, the robot 800 can perform work different from the component assembly work (for example, preparation of the next assembly work) even while the work cart 20 is not disposed at the first position, so that effective work efficiency can be enhanced.

When a maximum value of the operation speed of the robot 800 when performing the component assembly work is V1 and a maximum value of the operation speed of the robot 800 when performing work different from the component assembly work is V2, the control unit controls the operation speed of the robot 800 so as to satisfy V1>V2. From the viewpoint of achieving both safety and effective work efficiency, it is desirable to control the operation speed of the robot 800 so as to satisfy V1/2>V2>V1/10. The operation speed may be determined, for example, based on a trajectory of a specific portion (for example, an actuator mounted on a distal end) of the robot arm, or may be determined based on a trajectory of a portion having the highest movement speed during the work among portions forming the robot arm.

In addition, it is possible to provide a sensing unit that senses a possibility that a human enters the movable range of the robot 800 while performing work different from the assembly work. In a case where a possibility that a human enters is sensed, the operation of the robot 800 may be temporarily stopped, or the operation speed of the robot 800 may be further reduced. As a result, even in a case where the work cart 20 or the cart 110 that can function as an obstacle for suppressing an entry of a human is not disposed at the predetermined position, it is possible to cause the robot 800 to perform work different from the assembly work with high safety.

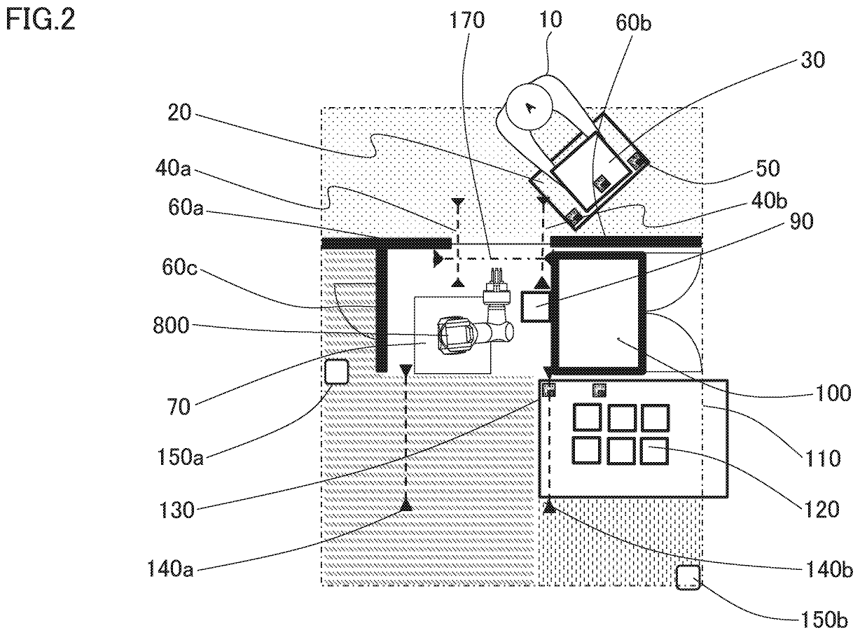

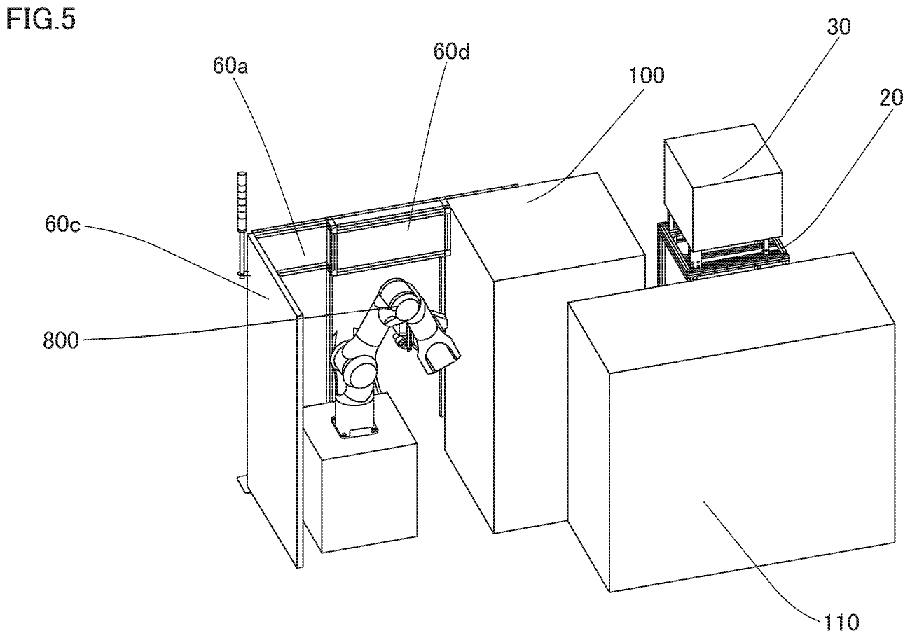

FIG. 2 is a schematic external view of an example of a situation in which the work cart 20 is not disposed at the first position, that is, a situation in which the robot 800 does not perform the component assembly work together with the operator 10, when viewed from above. FIG. 5 is a schematic view of the robot 800 in the same state as above when viewed from obliquely above. FIGS. 2 and 5 illustrate a state in which a gap through which a human can pass unconsciously (or easily) is present in at least a part of the periphery of the robot 800.

FIG. 2 illustrates a state in which the operator 10 moves to a place away from the first position while pushing the work cart 20. For example, the operator 10 moves the work cart 20 in order to transfer the component 30 to be assembled for which the component assembly is completed by the collaborative work with the robot 800 to the next process. The robot 800 can detect that the work cart is not at the first position by the sensor 40a and the sensor 40b. A gap through which a human can pass unconsciously (or easily) is present at the first position where the work cart 20 is not disposed.

Further, FIG. 2 illustrates a state in which the cart 110 is not disposed at the predetermined position in the direction of six o'clock with respect to the robot 800. For example, FIG. 2 illustrates a state in which the cart 110 (AGV), which is the kitting cart, is on the way of returning to the predetermined position after loading a new assembling component 120 at the component supply site. The robot 800 can detect that the cart 110 is not at the predetermined position by the sensor 140a and the sensor 140b. A gap through which a human can unconsciously (or easily) pass is present at the predetermined position in the direction of six o'clock where the cart 110 is not disposed.

In the present embodiment, the robot 800 includes a laser curtain 170 in order to enable sensing when a human enters the movable range of the robot 800 from the first position in a case where the work cart 20 is not disposed at the first position. The laser curtain 170 is a device capable of sensing the presence or absence of an object that blocks a curtain beam. In a case where the work cart 20 is disposed at the first position as illustrated in FIG. 1, the control unit of the robot 800 does not operate the laser curtain 170, but in a case where the work cart 20 is not disposed at the first position as illustrated in FIG. 2, the control unit operates the laser curtain 170.

When the laser curtain 170 senses that a human enters the movable range of the robot 800 from the first position, the control unit changes the control of the operation so as to temporarily stop the operation of the robot 800 or further reduce the operation speed of the robot 800.

Furthermore, in the present embodiment, the robot 800 includes a laser scanner 150a and a laser scanner 150b in order to enable sensing when a human enters the movable range of the robot 800 from the predetermined position in a case where the cart 110 is not disposed at the predetermined position in the direction of six o'clock. The laser scanner is a device that scans a region in the vicinity of the predetermined position with a laser, and can detect a human trying to enter the movable range of the robot 800 from the predetermined position. In a case where the cart 110 is disposed at the predetermined position in the direction of six o'clock as illustrated in FIG. 1, the control unit of the robot 800 does not operate the laser scanner 150a and the laser scanner 150b, but in a case where the cart 110 is not disposed at the predetermined position as illustrated in FIG. 2, the control unit operates the laser scanner 150a and the laser scanner 150b.

When the laser scanner 150a and the laser scanner 150b sense that a human enters the movable range of the robot 800 from the predetermined position, the control unit changes the control of the operation so as to temporarily stop the operation of the robot 800 or further reduce the operation speed of the robot 800.

### Configuration of Robot

Examples of a configuration of a control system and a mechanical mechanism of the robot according to the present embodiment will be described. FIG. 6 is a schematic block diagram illustrating the configuration of the control system of the robot 800. FIG. 7 is a schematic diagram illustrating a configuration of a main body and the like of the robot 800. A system according to the present embodiment refers to a mode including at least the robot 800, the work cart 20 serving as a movable device, and the control unit 200.

As illustrated in FIG. 6, a control unit 200, which is a computer that controls the entire robot 800, is communicably connected to the respective units. Examples of the units include the sensor 40a, the sensor 40b, the sensor 140a, the sensor 140b, the reading device that detects the marker 50, the reading device that detects the marker 130, the reading device that detects the marker 180, and the door switch of the safety fence 60c. The control unit 200 can acquire a sensing result from each unit.

Further, the control unit 200 is bidirectionally communicably connected to the laser curtain 170. The control unit 200 stops the operation of the laser curtain 170 when the work cart 20 is disposed at the first position, and operates the laser curtain 170 to acquire the sensing result when the work cart 20 is not disposed at the first position.

Further, the control unit 200 is bidirectionally communicably connected to the laser scanner 150a and the laser scanner 150b. When the cart 110 is not disposed at the predetermined position in the direction of six o'clock, the control unit 200 operates the laser scanner 150a and the laser scanner 150b to acquire the sensing result. When the cart 110 is disposed at the predetermined position in the direction of six o'clock, the operations of the laser scanner 150a and the laser scanner 150b are stopped.

The control unit 200 is bidirectionally communicably connected to an operation input unit 600 for operating the robot, such as a teaching pendant. The control unit 200 can receive information and a command related to work of the robot 800 from the operation input unit 600. Furthermore, the control unit 200 can transmit information regarding a state of the robot 800 to the operation input unit 600. The operation input unit 600 can display, on a display unit, an input screen for inputting an operation command for the robot 800 and information acquired from the robot 800. That is, a type of work performed by the robot 800, information regarding the control of the operation speed of the robot 800, and information regarding the position of the work cart 20 or the cart 110 can be displayed on the display unit. Such pieces of information may be displayed on the display unit included in the control unit 200.

The control unit 200 is bidirectionally communicably connected to a programmable logic controller (PLC) 700 that controls the operation of the robot 800. The control unit 200 transmits the operation command to the PLC 700 based on, for example, a work command from the operation input unit 600. The PLC 700 controls operations of a joint and an actuator of the robot 800 based on the operation command acquired from the control unit 200.

FIG. 7 is a schematic diagram illustrating the configuration of the main body and the like of the robot 800. The robot 800 includes an arm 400 serving as a movable unit, and the operation input unit 600 and the control unit 200 described above.

The control unit 200 is implemented by a computer using a microprocessor or the like, and can control the operation of the robot 800. As illustrated in FIG. 7, the computer implementing the control unit 200 includes a central processing unit (CPU) 501, a read only memory (ROM) 502 that stores a program for controlling each unit, a random access memory (RAM) 503 serving as a work area, a communication interface 504, and the like. The RAM 503 can be used for temporary storage of data such as a teaching point and a control command acquired from the operation input unit 600. The control unit 200 may be a computer constructed on a calculation resource group such as a cloud infrastructure.

The control unit 200 includes a plurality of functional blocks (not illustrated). Examples of the functional blocks include a work cart position determination unit that determines whether or not the work cart 20 is disposed at the first position, a cart position determination unit that determines whether or not the cart 110 is disposed at the predetermined position, a trajectory generation unit that generates a trajectory of each unit of the robot, and an operation speed control unit that controls the operation speed of the robot. A specific form of distribution or integration of the functional blocks is not limited to the above examples, and all or some of the functional blocks can be functionally or physically distributed and integrated in arbitrary units according to a use situation or the like. Such functional blocks can be implemented, for example, by the CPU 501 reading and executing a control program stored in a storage device or a non-transitory recording medium. Alternatively, some or all of the functional blocks may be implemented by hardware such as an application-specific integrated circuit (ASIC) included in the control unit 200.

The operation input unit 600 can be an operation device such as a teaching pendant (TP), for example, and may be another computer device (personal computer (PC) or server) capable of editing a robot program. The operation input unit 600 can be connected to the control unit 200 via a wired or wireless communication connection unit, and has user interface functions such as robot operation input and robot state display. The CPU 501 of the control unit 200 acquires, for example, teaching point data input through the operation input unit 600 via the communication interface 504. In addition, the CPU 501 generates a trajectory of each axis of the arm 400 based on the teaching point data input from the operation input unit 600, and transmits the trajectory as a control target value to the PLC 700 via the communication interface 504.

The arm 400 whose operation is controlled by the PLC 700 includes a base portion 401 fixed to the floor or a surface plate, links 421 to 426 that transmit displacement and force, and joints 411 to 416 that turnably or rotatably couple the links 421 to 426.

The robot 800 can perform work on a workpiece that is a work target object by a robot hand 427 mounted on a distal end of the arm 400. For example, the robot 800 can perform the component assembly work on the component 30 to be assembled by holding a component with the robot hand 427.

### Control of Operation of Robot

For example, as in the state illustrated in FIG. 1, in a case where the sensor 40a and the sensor 40b sense the presence of an object at the first position, and the marker 50 corresponding to the work cart 20 is read, the control unit 200 recognizes that the work cart 20 is disposed at the first position. On the other hand, when the marker 50 is not recognized even if the sensor 40a and the sensor 40b simultaneously sense an object as in a case where a person spreads both arms, the control unit 200 does not recognize that the work cart 20 is disposed at the first position.

When the marker 180 of the component 30 to be assembled, which is installed on the work cart 20, is detected in the state in FIG. 1, the control unit 200 recognizes that the component 30 to be assembled is placed on the work cart 20. On the other hand, when the marker 180 is not detected, the control unit 200 does not recognize that the component 30 to be assembled is placed on the work cart 20. In a case where it is recognized that the component 30 to be assembled is placed on the work cart 20, the control unit 200 can transmit an operation command to the PLC 700 so as to perform the assembly work at a high speed.

In the state in FIG. 1, in a case where the sensor 140a and the sensor 140b sense that the cart 110 is at the predetermined position, and the marker 130 is read, the control unit 200 recognizes that the cart 110 is at the predetermined position. On the other hand, in a case where the marker 130 is not recognized even if the sensor 140a and the sensor 140b sense an object, the control unit 200 does not recognize that the cart 110 is at the predetermined position. In a case where it is recognized that the work cart 20 is disposed at the first position, the component 30 to be assembled is placed on the work cart 20, and the cart 110 is disposed at the predetermined position, the control unit 200 can transmit an operation command to the PLC 700 so as to perform the assembly work at a high speed.

In this state, the control unit 200 stops sensing operations of the laser scanner 150a, the laser scanner 150b, and the laser curtain 170. Alternatively, even when the control unit 200 receives signals from the laser scanner 150a, the laser scanner 150b, and the laser curtain 170, the signals are not used for the control of the operation of the robot 800. However, in a case where the door switch of the safety fence 60c senses the opened state, the control unit 200 issues, to the PLC 700, a command to immediately stop the operation of the robot 800.

Meanwhile, in a case where at least one of the sensor 40a and the sensor 40b no longer senses an object at the first position in the state in FIG. 2, the control unit 200 recognizes that the work cart 20 is not disposed at the first position. In addition, in the state in FIG. 2, in a case where at least one of the sensor 140a and the sensor 140b no longer senses an object at the predetermined position, the control unit 200 recognizes that the cart 110 is not disposed at the predetermined position.

In a case where it is recognized that the work cart 20 is not at the first position, the cart 110 is not at the predetermined position, or the component 30 to be assembled is not placed on the work cart 20, the control unit 200 performs control such that the operation speed of the robot 800 becomes lower than that when performing work in FIG. 1.

In a case where the work cart 20 is not at the first position, the robot 800 can perform work different from the assembly work, but in view of a possibility that a person enters from the first position, the control unit 200 controls the robot 800 to perform work at an operation speed lower than that for the assembly work.

In a case where the cart 110 is not at the predetermined position, the robot 800 can perform the assembly work or work different from the assembly work. In this case, in view of a possibility that a person enters from the predetermined position, the control unit 200 performs control so as to perform work at an operation speed lower than that for the assembly work in a state in which the cart 110 is at the predetermined position.

In a case where the component 30 to be assembled is not placed on the work cart 20, the robot 800 can perform work different from the assembly work. In this case, since there is a possibility that a human enters the work region (movable region) of the robot 800 from a space above the work cart 20 where the component 30 to be assembled is absent, the control unit 200 controls the robot 800 to perform work at an operation speed lower than that for the assembly work.

The control unit 200 not only limits the operation speed of the robot 800, but also issues a stop command to the robot 800 in a case where the laser scanner 150a or the laser scanner 150b senses a person entering the periphery of the movable region of the robot 800. The control unit 200 issues a stop command to the robot 800 also in a case where the laser curtain 170 senses an entry of an object.

As described above, in the present embodiment, when the robot 800 performs the assembly work at a high speed, equipment that can function as an obstacle that cannot be unconsciously (or easily) crossed even if a human tries to enter the work region (movable range) of the robot 800 is disposed around the robot 800. In other words, the robot 800 performs the assembly work at a high speed in a case where the equipment that can function as an obstacle that cannot be unconsciously (or easily) crossed even if a human tries to enter the work region (movable range) of the robot 800 is disposed around the robot 800.

In a case where the equipment that can function as an obstacle that cannot be unconsciously (or easily) crossed even if a human tries to enter the work region (movable range) of the robot 800 is not disposed around the robot 800, the robot 800 performs work different from the assembly work at a lower speed than that for the assembly work. Furthermore, the sensing unit that senses a possibility that a human enters the movable range of the robot 800 is provided, and in a case where the entry of a human is sensed, the control unit changes the control of the operation of the robot 800 so as to temporarily stop the operation or further reduce the operation speed. The sensing unit that senses a possibility that a human enters the movable range of the robot 800 is not limited to the laser curtain 170, the laser scanner 150a, and the laser scanner 150b described above, and may be, for example, a camera having an image recognition function or an ultrasonic sensor.

The pieces of equipment disposed as an obstacle that cannot be unconsciously (or easily) crossed by a human, such as the safety fence 60a, the safety fence 60b, the safety fence 60c, the component storage 100, and the cart 110, desirably have heights that do not allow a human to enter the work range (movable range) of the robot 800. For example, the heights of the safety fence 60a, the safety fence 60b, the safety fence 60c, the component storage 100, and the cart 110 are set to heights exceeding 1500 mm.

As illustrated in FIGS. 3 and 4, the safety fence 60d that bridges the safety fence 60a and the safety fence 60b may be provided above the work cart 20 and the component 30 to be assembled. A height of the safety fence 60 d is set to be larger than 1500 mm, so that the operator 10 who performs work at the second position and the robot 800 cannot directly contact each other.

In addition, a size of a gap of each piece of equipment or a gap between the pieces of equipment may be set to 300 mm or less in order to achieve a structure in which a human hand cannot easily enter. It is desirable that the size of the gap is set to 30 mm or less.

The work performed by the robot 800 at an operation speed lower than that for the assembly work can be, for example, work of replacing the hand while the work cart 20 is not at the first position, work of picking up the assembling component 120 from the cart 110 while the work cart 20 is not at the first position, or work of picking up the assembling component from the component storage 100 while the work cart 20 is not at the first position. Alternatively, the work performed by the robot 800 at an operation speed lower than that for the assembly work can be work of attaching and detaching the hand while the cart 110 is not at the predetermined position, or work of assembling the assembling component 120 to the component 30 to be assembled while the cart 110 is not at the predetermined position. However, the work performed by the robot 800 at the lower operation speed is not limited thereto, and any work can be performed. Such work is performed at a low speed, but since the work is performed with high safety even during a period when the work cart 20 and the cart 110 are not present at predetermined positions, the effective work efficiency of the robot can be improved.

As described above, according to the present embodiment, it is possible to provide a technology capable of suppressing a decrease in a working speed of a robot that performs collaborative work with a person while ensuring safety of the person.

### Modified Embodiment

The present disclosure is not limited to the embodiments described above, and many modifications can be made within the technical idea of the present disclosure. For example, all or some of the different embodiments described above may be combined and implemented.

The control program capable of executing the robot control method described above and a computer-readable recording medium storing the control program are also included in the embodiments of the present disclosure.

The above-described embodiment can be applied to a robot capable of automatically performing an operation of expansion and contraction, bending and stretching, vertical movement, horizontal movement, or turning, or a combined operation thereof based on information of the storage device provided in the control device. There may be various types of robots such as a vertically articulated type robot, a parallel link type robot, and a linear joint type robot.

The work to be performed by the robot according to the embodiment is typically work related to manufacture of an article, which is represented by assembly of a component onto a member, assembly of components, transport, machining (including cutting, polishing, drilling, painting, bonding, welding, and the like), and cleaning. However, the robot according to the embodiment may perform other work.

The robot and the robot control method according to the embodiment can be applied to various machines and facilities such as an industrial robot, a service robot, and a processing machine operated by numerical control by a computer, in addition to production facilities.

The present disclosure can also be implemented by processing in which a program for implementing one or more functions of the embodiments is supplied to a system or a device via a network or a storage medium, and one or more processors in a computer of the system or the device read and execute the program. The present disclosure can also be implemented by a circuit (for example, an ASIC) that implements one or more functions.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-069575, filed Apr. 21, 2025, which is hereby incorporated by reference herein in its entirety.

What is claimed is:

1. A robot comprising:
a movable unit; and a control unit configured to control an operation of the movable unit,
wherein the robot is configured to perform, together with an operator, work on a member placed on a movable device, and
the control unit is configured to control an operation of the movable unit based on information regarding a position of the movable device.

2. The robot according to claim 1, wherein
the control unit is configured to change control of the operation of the movable unit according to whether or not the movable device is disposed at a first position, and
the first position is set between the movable unit and a second position set as a position of the operator in a case where the operator performs work on the member.

3. The robot according to claim 2, wherein
the movable unit is configured to perform the work on the member from a side opposite to the second position in a case where the movable device on which the member is placed is disposed at the first position.

4. The robot according to claim 2, wherein
the control unit is configured to change, in a case where the movable device is disposed at the first position, the control of the operation such that an operation speed of the movable unit is increased as compared with a case where the movable device is not disposed at the first position.

5. The robot according to claim 2, further comprising a sensing unit configured to sense whether or not the movable device is disposed at the first position,
wherein the control unit is configured to acquire, from the sensing unit, information indicating whether or not the movable device is disposed at the first position.

6. The robot according to claim 5, wherein
the sensing unit includes a sensor configured to sense whether or not an object is present at the first position.

7. The robot according to claim 5, wherein
the sensing unit includes an identification unit configured to identify whether or not an object present at the first position is the movable device.

8. The robot according to claim 2, wherein
equipment having a height larger than a predetermined height is disposed in a direction different from a direction in which the first position is present in a case of being viewed from the movable unit in at least a part of a periphery of the movable unit.

9. The robot according to claim 8, wherein
the predetermined height is 1000 mm.

10. The robot according to claim 8, wherein
the equipment includes at least one of a safety fence, a component storage, a hand attachment and detachment workbench for attaching and detaching a hand to and from the movable unit, and a table on which the member for which the work is completed and/or a component used for the work is placed.

11. The robot according to claim 8, wherein
the equipment is a hand attachment and detachment workbench for attaching and detaching a hand to and from the movable unit, and
the control unit is configured to operate, in a case where the movable device is not disposed at the first position, the movable unit at an operation speed lower than an operation speed in a case where the work is performed on the member to attach or detach the hand to or from the movable unit.

12. The robot according to claim 8, wherein
the equipment is a movable cart on which the member for which the work is completed and/or a component used for the work is placed, and
the control unit is configured to change the control of the operation of the movable unit according to whether or not the movable cart is disposed around the movable unit.

13. The robot according to claim 12, further comprising a sensing unit configured to sense whether or not the movable cart is disposed around the movable unit,
wherein the control unit is configured to acquire, from the sensing unit, information indicating whether or not the movable cart is disposed around the movable unit.

14. The robot according to claim 8, wherein
the equipment is a safety fence including an openable and closable door, and
the control unit is configured to change the control of the operation of the movable unit according to whether the door is open or closed.

15. The robot according to claim 1, wherein
the work performed by the movable unit together with the operator is assembling of a component to the member.

16. A control method for controlling a robot that includes a movable unit and a control unit configured to control an operation of the movable unit and is configured to perform, together with an operator, work on a member placed on a movable device,
the control method comprising:
controlling, by the control unit, the operation of the movable unit based on information regarding a position of the movable device.

17. A manufacturing method for manufacturing an article by using the robot according to claim 1,
the manufacturing method comprising:
manufacturing the article by using the member,
wherein the work performed, together with the operator, by the movable unit on the member is included as at least a part of the manufacturing of the article.

18. A system comprising:
a robot including a movable unit;
a control unit configured to control an operation of the movable unit; and
a movable device,
wherein the robot is configured to perform, together with an operator, work on a member placed on the movable device, and
the control unit is configured to control the operation of the movable unit based on information regarding a position of the movable device.

19. A non-transitory computer-readable recording medium recording a program for causing a computer included in the control unit to execute the control method for controlling the robot according to claim 16.
